(19) United States
(12) Patent Application Publication
(10) Pub. No.: US 2008/0309024 A1
(43) Pub. Date: Dec. 18, 2008

(54) Sealing Element for a Shaft and Vehicle Component

(76) Inventor: Michael vom Schemm, Reinfeld (DE)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 12/140,122

(22) Filed: Jun. 16, 2008

(30) Foreign Application Priority Data
Jun. 15, 2007 (DE) DE102007028396.4

(51) Int. Cl. F16J 15/32

(52) U.S. Cl. 277/556

(57) ABSTRACT

A sealing element for a shaft, in particular a crank shaft of an internal combustion engine, with a sealing lip made of a polymer material, which in operation is arranged on said shaft to be funnel-shaped towards the sealed space, and which comprises, in a section in contact with said shaft, a conveying structure to return leaking medium back into the sealed space, wherein said sealing lip comprises, on the opposite side, at least one structure running substantially in the axial-radial direction which leads to the formation of a leakage channel in case said sealing lip is turned inside out towards the atmosphere side.

### RELATED APPLICATIONS

The application claims priority under 35 U.S.C. §119(e) of German Patent Application No. DE 102007028396.4, filed on Jun. 15, 2007, which is hereby incorporated by reference in its entirety.

### FIELD OF INVENTION

Embodiments of the invention relate to a sealing element for a shaft. Specific embodiments pertain to a sealing element for a crank shaft of a motor vehicle. Further specific embodiments are directed to a vehicle component, such as a housing part or sealing flange.

### BACKGROUND OF INVENTION

A sealing element with an elastomer sealing lip is known, for example, from DE 100 33 446 C2. The sealing lip in operation is arranged on the shaft to be funnel-shaped towards the sealed space. During assembly, however, there is a certain risk that the sealing lip is turned inside out towards the atmosphere side. In the most unfavourable case, this fault cannot be detected by the static sealing test of the engine when the inside of the sealing lip tight-fittingly lies around the shaft. In the operation of the engine, the sealing lip improperly turned inside out then leaks because the inside of the sealing lip generally is not designed as a dynamic sealing.

From DE 38 30 711 A1 it is known for a radial shaft seal comprising an annular spring for loading the sealing lip to provide, on the side of the sealing lip opposite the shaft, a wave-shaped profile running in the circumferential direction or a row of knob-shaped projections in order to create an intended leakage during the air pressure test in the case of a sealing lip improperly turned inside out. In a sealing element without an annular spring such a row of knobs extending in the circumferential direction in the form of a shaft would not be suitable to generate a leak with a sealing lip improperly turned inside out.

### BRIEF SUMMARY

An object of the invention is to provide a sealing element enabling the reliable detection with simple means of a sealing lip improperly turned inside out.

Embodiments of the invention solve this object. Due to the structure according to embodiments of the invention on the inside of the sealing lip, which can include in particular a protruding and/or inwardly protruding element with respect to the inside surface, tight fitting of the sealing lip around the shaft is prevented in case the sealing lip is completely or partially turned inside out towards the atmosphere side and, consequently, at least one leakage channel is formed which leads to the indication of leakage in the pressure test after motor assembly.

According to embodiments of the invention, the axial-radial course of the structure is thereby of particular importance because, in contrast to a structure running in the circumferential direction, it makes the formation of a leakage channel over the entire axial length of the contact portion between the sealing lip and the shaft possible for a sealing lip according to the invention without an annular spring. The axial-radial structure is substantially simpler to manufacture than known helical ribs running on the inside of the sealing lip. Axial and radial refer to the longitudinal axis of the shaft. Axial-radial means in a plane containing the longitudinal axis of the shaft.

The invention can be used for sealing lips, in particular, based on elastomer material, in particular rubber, including thermoplastic elastomers, but includes also sealing lips based on PTFE.

### BRIEF DESCRIPTION OF DRAWINGS

The invention is explained in the following on the basis of advantageous embodiments with reference to the enclosed drawings. In the drawings:

FIG. 1 shows a cross-section through a radial shaft seal in the operative state;

FIG. 2 shows a perspective view of the radial shaft seal ring from FIG. 1;

FIG. 3 shows a cross-section through the radial shaft sealing ring from FIG. 1 in the condition turned inside out; and

FIGS. 4 and 5 show perspective views of a radial shaft seal ring in alternative embodiments.

### DETAILED DISCLOSURE

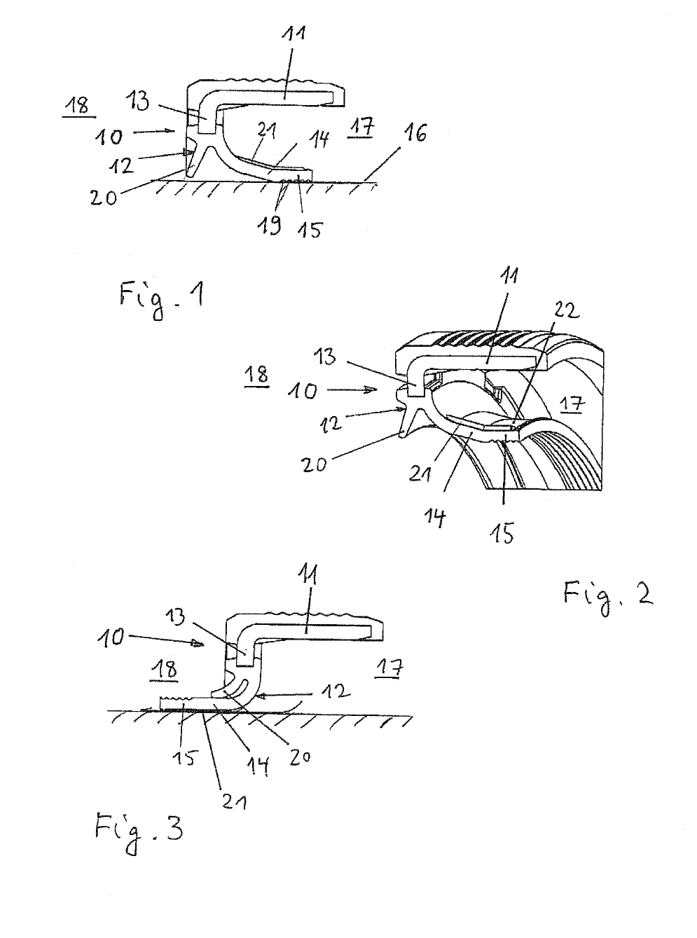

Referring to FIGS. 1-5, the radial shaft seal 10 comprises an angular holding part 11 with a radial section 13, to which a sealing element 12 is bonded. The holding part 11, can in particular be part of a sealing flange for connection with a housing component of the engine and/or a motor control gear or form such a housing component.

The holding part 11 is made preferably of metal, in particular sheet steel or a suitable plastic. The sealing element 12 is made preferably of an elastomer, in particular rubber.

The sealing element 12 includes a sealing lip 14, which lies in the operational state shown in FIG. 1 with a sealing section 15 over a certain axial length on the crank shaft 16, to seal the interior 17 against the surrounding side 18. The sealing section 15 comprises helical recovering channels 19 to return medium from between the sealing section 15 and the shaft 16 back into the interior 17. The sealing element 12 can further comprise a protective lip 20 on the atmosphere side to prevent the penetration of debris from the atmosphere side 18 into between the sealing section 15 and the shaft 16.

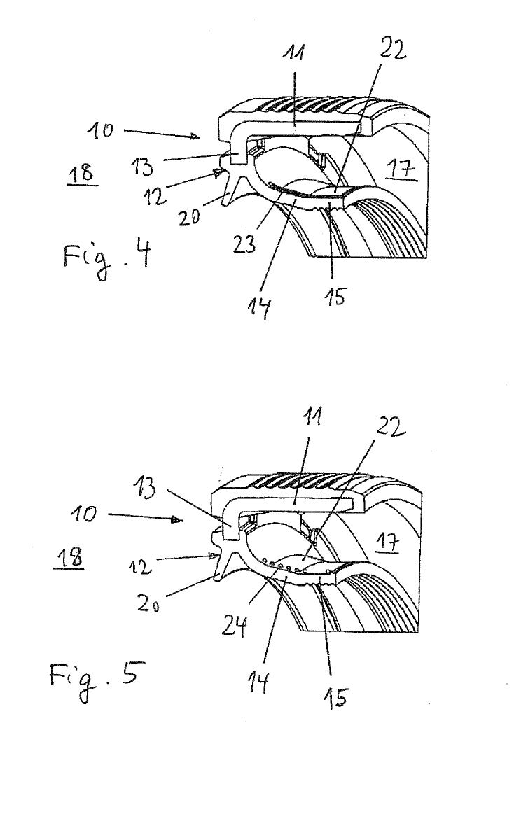

On the inside of the sealing lip 14 opposite the shaft 16 in the embodiment according to FIGS. 1 to 3 at least one rib 21 running in the axial-radial direction is present which is protruding above the remaining surface 22 of the inner side of the sealing lip 14 and is preferably integrally formed with the sealing lip 14. In the case of a sealing lip 14 improperly turned inside out towards the atmosphere side 18 as shown in FIG. 3, the rib 21 lying on the shaft 16 prevents a tight fitting of the sealing lip 14 around the shaft 16. Leakage channels extending laterally in an axial-radial direction are formed next to the rib 21, which allow the detection of the faulty assembly condition according to FIG. 3 in the following static pressure test. The axial-radial extension of the rib 21 and/or more generally of the structure generating the leakage channel is preferably at least as large as the axial length of the sealing section 15.

In the alternative embodiment according to FIG. 4, at least one axial-radial groove 23 is formed on the inner side of sealing lip 14 as the leakage channel-generating structure. The groove 23 is inwardly protruding with respect to the remaining surface 22 of the sealing lip 14 and forms a leakage channel itself in the case of faulty mounting where the sealing lip 14 is turned inside out towards the atmosphere side 18.

In the alternative embodiment according to FIG. 5 at least one axial-radial row of protruding knobs 24 is formed as a leakage channel-generating structure on the inner side of the sealing lip 14, preferably integrally formed with the latter.

In principle one leakage channel-generating structure 21, 23, 24 at the circumference of the sealing lip 14 is sufficient. The sealing lip 14 can also comprise a plurality of leakage channels preferably distributed evenly along the circumference. A combination of various types of structures generating leakage channels, for example, webs 21 and rows of knobs 24 is possible.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A sealing element for a shaft, comprising:
a sealing lip made of a polymer material, which in operation is arranged on the shaft to be funnel-shaped towards the sealed space, wherein said sealing lip comprises, in a section in contact with the shaft, a conveying structure to return leaking medium back into the sealed space, wherein said sealing lip comprises, on the opposite side, at least one structure running substantially in the axial-radial direction that leads to the formation of a leakage channel in case said sealing lip is turned inside out towards the atmosphere side.

2. The sealing element according to claim 1, wherein said sealing lip is made of an elastomer material.

3. The sealing element according to claim 1, wherein said at least one structure includes at least one element protruding with respect to the surface on the inside of said sealing lip.

4. The sealing element according to claim 3, wherein said at least one protruding element is integrally formed with said sealing lip.

5. The sealing element according to claim 3, wherein said at least one protruding element is a rib running substantially in the axial-radial direction.

6. The sealing element according to claim 3, wherein said at least one protruding element is a row of knobs running substantially in the axial-radial direction.

7. The sealing element according to claim 1, wherein said conveying structure comprises at least one element protruding inwardly with respect to the surface of the atmosphere side of said sealing lip.

8. The sealing element according to claim 7, wherein said inwardly protruding element is a groove in said sealing lip running substantially in the axial-radial direction.

9. The sealing element according to claim 1, wherein the shaft is a crank shaft of an internal combustion engine.

10. A vehicle component, comprising:
an integrated sealing element for a shaft, said sealing element comprising a sealing lip made of a polymer material, which in operation is arranged on said shaft to be funnel-shaped towards the sealed space, and wherein the sealing lip comprises, in a section in contact with said shaft, a conveying structure to return leaking medium back into the sealed space, wherein said sealing lip comprises, on the opposite side, at least one structure running substantially in the axial-radial direction that leads to the formation of a leakage channel in case said sealing lip is turned inside out towards the atmosphere side.

11. The vehicle component according to claim 10, wherein said sealing lip is made of an elastomer material.

12. The vehicle component according to claim 10, wherein said at least one structure includes at least one element protruding with respect to the surface on the inside of said sealing lip.

13. The vehicle component according to claim 12, wherein said at least one protruding element is integrally formed with said sealing lip.

14. The vehicle component according to claim 12, wherein said at least one protruding element is a rib running substantially in the axial-radial direction.

15. The vehicle component according to claim 12, wherein said at least one protruding element is a row of knobs running substantially in the axial-radial direction.

16. The vehicle component according to claim 10, wherein said conveying structure comprises at least one element protruding inwardly with respect to the surface of the atmosphere side of said sealing lip.

17. The vehicle component according to claim 16, wherein said inwardly protruding element is a groove in said sealing lip running substantially in the axial-radial direction.

18. The vehicle component according to claim 10, wherein the vehicle component is a housing part.

19. The vehicle component according to claim 10, wherein the vehicle component is a sealing flange.

20. The vehicle component according to claim 10, wherein the shaft is a crank shaft of an internal combustion engine.
